(19) United States
(12) Patent Application Publication
(10) Pub. No.: US 2007/0182053 A1
(43) Pub. Date: Aug. 9, 2007

(54) Continuous method for the production of a pigment masterbatch

(76) Inventors: Volker Hoellein, Frankfurt am Main (DE); Leonhard Unverdorben, Nidderau (DE); Thilo Kind, Koenigstein (DE); Jose Maria Pina, Barcelona (ES)

Correspondence Address: CLARIANT CORPORATION;INTELLECTUAL PROPERTY DEPARTMENT, 4000 MONROE ROAD, CHARLOTTE, NC, 28205, US

(21) Appl. No.: 10/567,308

(22) PCT Filed: Jul. 28, 2004
(86) PCT No.: PCT/EP04/08420

§ 371 Date: Aug. 22, 2006

(30) Foreign Application Priority Data
Aug. 6, 2003 (DE) 10335863.3

(51) Int. Cl. B29B 9/06

(52) U.S. Cl. 264/141; 264/211.23

(57) ABSTRACT

The invention relates to a method for the production of a pigment masterbatch by extrusion, wherein a) a thermoplastic polymer in granular or powder form is metered continuously into a twin-screw extruder; b) the polymer metered in is melted in the extruder; c) a pumpable pigment press cake containing pigment, water and/or organic solvent is metered continuously into the molten polymer through an inlet port of the extruder under elevated pressure, the pressure being sufficiently high that the boiling point of the water and/or organic solvent is higher than the internal temperature of the extruder in the region of this inlet port; d) optionally a flow improver is added; e) the pigment is dispersed into the molten polymer from the press cake by the action of shear forces; f) the water and/or organic solvent are removed through at least one outlet port of the extruder, under elevated pressure, the pressure being sufficiently high that the boiling point of the water and/or organic solvent is higher than the internal temperature of the extruder in the region of this outlet port; g) the pigmented polymer melt is discharged from the extruder, cooled and granulated.

The present invention relates to pigment concentrates in thermoplastic polymers.

Pigment concentrates in thermoplastic polymers, referred to as pigment masterbatches for short, have long been known and are usually used in the plastics industry as a readily meterable stock mixture for coloring plastics. The thermoplastic polymer (carrier) is tailored to the respective end product.

Continuous and batchwise methods are known for the industrial production of pigment masterbatches. In all known methods, the pigment is usually used in powder form, which entails disadvantages in terms of process engineering, such as, for example, complicated pretreatment steps (drying, milling, introduction of additives, premixing) and possibly additional upstream dispersing steps. In order to disperse pulverulent pigments in the thermoplastic carrier, dispersants, such as waxes, oils or stearates, are generally added. The added amounts of the dispersants can be up to 40% by weight or more. These substances are, however, undesired in the masterbatch since they may lead to problems during the processing or to poorer quality in the end product. Furthermore, even by adding these auxiliaries, it is not always ensured that optimum dispersing will be achieved. Furthermore, with the use of powder pigments for the production of highly pigmented pigment masterbatches, the low bulk density thereof is disadvantageous during direct processing in the extruder.

U.S. Pat. No. 4,474,473 and U.S. Pat. No. 6,273,599 disclose continuous flushing methods for pigments, wherein aqueous pigment press cakes are converted into a hydrophobic organic phase. Flowable pigment dispersions which are suitable for use in printing inks and paints are formed.

The object of the invention was to provide a continuous economical method for the production of pigment masterbatches which avoids the process engineering disadvantages described above, can dispense with the use of relatively large amounts of dispersants and gives particularly homogeneous products.

This object could be achieved by a special extrusion method, as defined below.

The invention relates to a method for the production of a pigment masterbatch by extrusion, wherein
a) a thermoplastic polymer in granular or powder form is metered continuously into a preferably corotating twin-screw extruder;
b) the polymer metered in is melted in the extruder;
c) a pumpable pigment press cake containing preferably from 5 to 35% by weight of pigment, water and/or organic solvent is metered continuously into the molten polymer through an inlet port of the extruder under elevated pressure, the pressure being sufficiently high that the boiling point of the water and/or organic solvent is higher than the internal temperature of the extruder in the region of this inlet port;
d) optionally a flow improver is added for optimizing the metering;
e) the pigment is dispersed into the molten polymer from the press cake by the action of shear forces;
f) the water and/or organic solvent are removed through at least one outlet port of the extruder, which is. preferably combined with a twin-screw lock, under elevated pressure, the pressure being sufficiently high that the boiling point of the water and/or organic solvent is higher than the internal temperature of the extruder in the region of this outlet port;
g) the pigmented polymer melt is discharged from the extruder, cooled and granulated.

Expediently, the process according to the invention is controlled and regulated by fully automatic measurement and regulation instrumentation. It is a continuous method which, in contrast to the known batch methods (for example flushing on a kneader at atmospheric pressure and temperatures below the normal boiling point of water), permits economical throughput rates at higher pressure and elevated temperature.

The method of the invention is suitably implemented using a twin-screw extruder which has a length/diameter ratio of 25 or greater and has a device for feeding in the thermoplastic polymer, thereafter an extrusion zone for melting the thermoplastic polymer, thereafter an inlet port for metering in the pigment press cake under elevated pressure, thereafter an extrusion zone for dispersing the pigment particles into the molten polymer by the action of shear forces, and thereafter one or more outlet apparatus(es) for removing the water and/or organic solvent from the pigment press cake under elevated pressure. The process parameters (temperature and pressure in the extruder, pressure difference when separating off water and/or solvent and all flow rates) are preferably regulated by means of a process control system.

Suitable thermoplastic polymers are the plastics usually suitable for the masterbatch production, in particular polyethylene, polypropylene, polystyrene and modifications thereof and EVA.

Particularly suitable pigments are organic pigments. Examples of organic pigments in the context of the invention are monoazo pigments, disazo pigments, disazo condensation pigments, laked azo pigments, triphenylmethane pigments, thioindigo pigments, thiazineindigo pigments, perylene pigments, perinone pigments, anthanthrone pigments, diketopyrrolopyrrole pigments, dioxazine pigments, quinacridone pigments, phthalocyanine pigments, isoindolinone pigments, isoindoline pigments, benzimidazolone pigments, naphthol pigments and quinophthalone pigments.

Expediently, the plastics powder or granules passes or pass from a storage container by gravimetric metering by means of a conveying screw into the extruder. The shear forces of the operating twin-screw extruder which act on the plastics particles metered in and the action of heat due to electrical heaters installed externally on the extruder barrel result in plastication of the plastic.

The pigment press cake expediently contains from 5 to 35% by weight of pigment in order to be readily pumpable. For improving the flow properties, it is furthermore possible to add a customary flow improver, preferably surface-active substances, such as oxalkylates or functionalized polymers. The pigment press cake is preferably aqueous, but organic solvents, such as, for example, chlorobenzenes, monohydric or polyhydric alcohols, ethers and esters thereof, e.g. alkanols, in particular having 1 to 6 carbon atoms, such as, for example, methanol, ethanol, propanol, isopropanol, butanol, isobutanol or amyl alcohol; dihydric or trihydric alcohols, in particular having 2 to 5 carbon atoms, e.g. ethylene glycol, propylene glycol, 1,3-propanediol, 1,4-butanediol, 1,5-pentanediol, 1,6-hexanediol, 1,2,6-hexanetriol, glycerol, diethylene glycol, dipropylene glycol, triethylene glycol, polyethylene glycol, tripropylene glycol or polypropylene glycol; lower alkyl ethers of polyhydric alcohols, such as, for example, ethylene glycol monomethyl, monoethyl or monobutyl ether, triethylene glycol monomethyl or monoethyl ether; ketones and ketone alcohols, such as, for example, acetone, methyl ethyl ketone, diethyl ketone, methyl isobutyl ketone, methyl pentyl ketone, cyclopentanone, cyclohexanone or diacetone alcohol; amides, such as, for example, dimethylformamide, dimethacetamide or N-methylpyrrolidone, toluene and n-hexane, exclusively or as a mixture with water, may also be present.

In order to prevent evaporation of the water and/or solvent, the pigment press cake is metered into the extruder under elevated pressure, preferably by pump (for example an eccentric screw pump) at a pressure of from 1 to 30 bar. To ensure that the polymer melting in the extruder remains flowable, it is expedient to heat the metered-in pigment press cake shortly before entry into the extruder to a temperature of from 20 to 220° C., preferably from 60 to 180° C. The ratios of the polymer to the pigment press cake should be chosen so that the resulting pigment masterbatch contains from about 10 to 70% by weight, preferably from 30 to 50% by weight, of pigment and from about 30 to 90% by weight, preferably from 50 to 70% by weight, of thermoplastic polymer.

In the subsequent extrusion zone, the transfer of the pigment into the polymer takes place. A suitable screw design in the interior of the extruder results in the phase transfer of the pigment from the pigment press cake into the plastics melt and effective dispersing of the pigment particles in the polymer.

The removal of the water and/or solvent generally takes place at temperatures above 100° C., preferably from 120° C. to 240° C., and under elevated pressure (value dependent on the type of liquid to be separated off). Consequently, no heat of vaporization is withdrawn from the system; the pigment/polymer melt remains in the plastic phase. Regulation of the pressure difference, preferably fully automatic regulation of the pressure difference with the aid of a control valve, prevents vaporization of the liquid to be separated off in the extruder, the result of which would be that, owing to the relatively large volume of the gas, the kinetic energy on emergence from the system would be so great that parts of the pigment/polymer melt would be entrained in the gas stream. The water and/or solvent is preferably separated off in liquid form via one or more twin-screw locks, which are sealed for a pressure up to 30 bar, by means of a constant pressure difference, and then cooled and let down. The heat energy of the water and/or solvent separated off can be recycled and can be used, for example, for initial heating of the press cake before it is sprayed into the extruder.

Residual amounts of water and/or solvent which still remain can be removed from the pigmented polymer melt by means of a downstream devolatilization device (atmospheric or vacuum) on the extruder.

The pigmented polymer melt is then discharged from the extruder, and the resulting pigmented polymer extrudates are cooled, for example in a water bath, and granulated.

Compared with conventional production methods for masterbatches, for example the hot-cold mixing method, the method according to the invention provides comparable space-time yields of the overall process, a lower overall energy consumption and surprisingly also better product qualities with regard to the dispersing of the pigments in combination with a substantially reduced proportion of dispersants or omission of dispersants. This manifests itself in particular in lower filter values and better film ratings.

Filter value and film rating describe the dispersing quality of a pigment in a masterbatch. In the case of the filter value, a defined amount of masterbatch is melted in a single-screw extruder with downstream gear pump and is pumped through a screen having a defined mesh size. If the masterbatch contains incompletely dispersed pigment particles (pigment agglomerates), these stick in the meshes of the screen. As a result, the flow cross section of the screen decreases, which leads to a pressure increase before the screen. The specific pressure difference from the start to the end of the test is the so-called filter value.

For evaluating the film rating, a blown film is produced and is colored by means of the masterbatch to be tested. Pigment agglomerates are then visible as specks in the film. The number of specks (defect index) and size are evaluated relative to a reference sample.

Correlation of defect index and film rating:

| Defect index (Fl) | Film rating |
|---|---|
| 0-5 | 1 |
| 6-10 | 1-2 |
| 11-100 | 2 |
| 101-200 | 2-3 |
| 201-300 | 3 |
| 301-400 | 3-4 |
| 401-600 | 4 |
| 601-1000 | 4-5 |
| >1000 | 5 |

In the following examples, % denotes percent by weight.

### EXAMPLE 1

For the production of the masterbatch, a corotating twin-screw extruder having a screw diameter of 27 mm and an UD ratio of 48 (12 barrels; 1 barrel corresponds to 4D) was used. The speed of the screws was 700 revolutions per minute. FIG. 1 shows the basic design of the extruder and the temperature distribution in the extruder.

Here, polyethylene granules (®Riblene MR 10) were metered continuously at constant feed rate (12 kg/h) into the first barrel of the extruder by gravimetric metering. In the following two barrels, the polymer was melted. In the 4th barrel, the aqueous press cake (pigment content: 25% by weight of PV true yellow HG/P.Y. 180) was metered in by means of an eccentric screw pump (likewise continuously and at constant feed rate of 32 kg/h). The pressure here was 7 bar. The temperature at the inlet port of the extruder was 140° C. In barrels 5 and 6, the pigment was introduced into the polymer and dispersed. The water was then removed from barrels 7 and 10 at temperatures >100° C. by means of two twin-screw locks at in each case 200 revolutions per minute. Barrels 8, 9 and 11 serve for thorough dispersing of the pigment in the polymer. By means of a die plate, the polymer extrudate was then transported out of the extruder, cooled in a water bath, dried with the aid of suction and granulated.

[image]

The product produced comprises dry masterbatch granules having a pigment content of 40% and a polyethylene content of 60%. Although no wax or a similar additive was added, this masterbatch has better dispersion of the pigment in the plastic than a comparable product standard produced conventionally (40% of pigment, 40% of wax, 20% of polyethylene, hot-mixed in a high-speed mixer and then cooled in a cooling mixer and extruded). Table 1 compares film rating and filter value for these.

TABLE 1
Film rating and filter value of a masterbatch according
to the invention method and a masterbatch standard

| | | Filter value |
|---|---|---|
| | Film rating/Fl | [bar/g] |
| Masterbatch from press cake | 2/33 | 0.2 |
| according to method described | | |
| Product standard (comparison) | 2-3/152 | 0.35 |

### EXAMPLE 2

For the production of the masterbatch, a corotating twin-screw extruder having a screw diameter of 40 mm and an UD ratio of 52 (13 barrels; 1 barrel corresponds to 4D) was used. The speed of the screws was 500 revolutions per minute.

FIG. 2 shows the basic design of the extruder.

[image]

Here, polyethylene granules (MFI 36) were metered continuously at constant feed rate of 17.5 kg/h into the first barrel of the extruder by gravimetric metering. In the following two barrels, the polymer was melted. In the 4th barrel, the aqueous press cake (pigment content: 20% by weight of PV fast pink E/P.R. 122) was metered in via an eccentric screw pump (likewise continuously and at constant feed rate of 37.6 kg/h). The pressure here was 8 bar. The temperature at the inlet port of the extruder was 160° C. In order to obtain a constantly pumpable press cake, an additive was also introduced into the press cake for improving the flow behavior (acrylate polymer base; 1%, based on the pigment content). In barrels 5 and 6, the pigment was introduced into the polymer and dispersed. The water was removed from barrels 7 and 10 at temperatures >100° C. via two twin-screw locks (1:300 revolutions per minute; 2:200 revolutions per minute). Barrels 8, 9 and 11 serve for further dispersing the pigment in the polymer. Barrel 12 has a vacuum connection for removing residual moisture from the pigment/polymer melt. The polymer extrudates were transported out of the extruder via a die plate, cooled in a water bath, dried with the aid of suction and granulated.

The product produced comprised dry masterbatch granules having a pigment content of 29.9%, an additive content of 0.3% and a polypropylene content of 69.8%. Compared with a conventional product standard, this masterbatch has a better film rating and a better filter value (cf. Table 2). Conventional product standard: 30% of pigment, 30% of wax, 40% of polypropylene, hot-mixed in a high-speed mixer and then cooled in a cooling mixer and extruded).

TABLE 2
Film rating and filter value of a masterbatch according
to the invention method and of a masterbatch standard

| | | Filter value |
|---|---|---|
| | Film rating/Fl | [bar/g] |
| Masterbatch from press cake | 2-3/128 | 0.4 |
| according to method described | | |
| Product standard (comparison) | 4/530 | 1.2 |

1. A method for the production of a pigment masterbatch by extrusion, comprising the steps of:
a) metering continuously, a thermoplastic polymer in granular or powder form into a twin-screw extruder;
b) melting the polymer in the extruder to form a molten polymer;
c) metering, continuously, a pumpable pigment press cake containing pigment, water and/or organic solvent into the molten polymer through an inlet port of the extruder under elevated pressure, the pressure being sufficiently high that the boiling point of the water and/or organic solvent is higher than the internal temperature of the extruder in the region of the inlet port;
d) optionally, adding a flow improver;
e) dispersing the pigment into the molten polymer from the press cake by the action of shear forces;
f) removing the water and/or organic solvent though at least one outlet port of the extruder, under elevated pressure, the pressure being sufficiently high that the boiling point of the water and/or organic solvent is higher than the internal temperature of the extruder in the region of the at least one outlet port to a form a pigmented polymer melt; and
g) discharging the pigmented polymer melt from the extruder
h) cooling the pigmented polymer melt to form a pigmented polymer; and
i) granulating the pigmented polymer.

2. The method as claimed in claim 1, wherein the twin screw extruder is a corotating twin-screw extruder.

3. The method as claimed in claim 1, wherein the pigment press cake contains from 5 to 35% by weight of pigment.

4. The method as claimed in claim 1, wherein the at least one outlet port is combined with one or more twin-screw locks.

5. The method as claimed in claim 1, wherein the thermoplastic polymer is a polyethylene, polypropylene, polystyrene or ethylene vinyl acetate.

6. The method as claimed in claim 1, wherein the pigment is an organic pigment selected from the group consisting of the monoazo pigments, disazo pigments, disazo condensation pigments, laked azo pigments, triphenylmethane pigments, thioindigo pigments, thiazineindigo pigments, perylene pigments, perinone pigments, anthranthrone pigments, diketopyrrolopyrrole pigments, dioxazine pigments, quinacridone pigments, phthalocyanine pigments, isoindolinone pigments, isoindoline pigments, benzimidazolone pigments, naphthol pigments and quinophthalone pigments.

7. The method as claimed in claim 1, wherein the flow improver is added and wherein the flow improver is a surface-active substance.

8. The method as claimed in claim 1, wherein the pigment masterbatch contains from 10 to 70% by weight of pigment and from 30 to 90% by weight of thermoplastic polymer.

9. The method as claimed in claim 1, wherein the heat of the water and/or solvent removed via the at least one outlet port is used for heating the press cake to be metered in step b).

10. The method as claimed in claim 1, wherein the removal of water and/or solvent in step f) is effected by fully automatic regulation of the pressure difference.

11. The method as claimed in claim 10, the fully automatic regulation of the pressure is achieved by a control valve.

12. A method for the production of a pigment masterbatch by extrusion, comprising the steps of:
a) metering continuously, a thermoplastic polymer in granular or powder form into a twin-screw extruder;
b) melting the polymer in the extruder to form a molten polymer;
c) metering, continuously,a pumpable pigment press cake containing pigment, water and/or organic solvent into the molten polymer through an inlet port of the extruder under elevated pressure, the pressure being sufficiently high that the boiling point of the water and/or organic solvent is higher than the internal temperature of the extruder in the region of the inlet port;
d) optionally, adding a flow improver;
e) dispersing the pigment into the molten polymer from the press cake by the action of shear forces;
f) removing the water and/or organic solvent through at least one outlet port of the extruder, under elevated pressure, the pressure being sufficiently high that the boiling point of the water and/or organic solvent is higher than the internal temperature of the extruder in the region of the at least one outlet port to a form a pigmented polymer melt; and
g) discharging the pigmented polymer melt from the extruder.
